(19) United States
(12) Patent Application Publication
(10) Pub. No.: US 2023/0266957 A1
(43) Pub. Date: Aug. 24, 2023

(54) EXECUTION OF CONTAINER IMAGES IN A TRUSTED EXECUTION ENVIRONMENT

(71) Applicants: Jie Ren, Shanghai (CN); Mikko Ylinen, Lempaala (FI); Liang Yang, Beijing (CN); Liang Fang, Shanghai (CN); Malini Bhandaru, San Jose, CA (US); Ziye Yang, Shanghai (CN); Hairong Chen, Shanghai (CN)

(72) Inventors: Jie Ren, Shanghai (CN); Mikko Ylinen, Lempaala (FI); Liang Yang, Beijing (CN); Liang Fang, Shanghai (CN); Malini Bhandaru, San Jose, CA (US); Ziye Yang, Shanghai (CN); Hairong Chen, Shanghai (CN)

(21) Appl. No.: 18/139,078

(22) Filed: Apr. 25, 2023

(30) Foreign Application Priority Data
Dec. 14, 2022 (WO) PCT/CN2022/138952

(51) Int. Cl. G06F 8/61; G06F 8/65

(52) U.S. Cl. CPC G06F 8/63; G06F 8/65

(57) ABSTRACT

Operations are described for executing application images in a trusted execution environment (TEE). These operations can include retrieving a user application image and generating a bundle for the application image by mounting an overlay onto the application image. The overlay can include library functionality for operating in the TEE. The operations can further include providing the bundle for execution in the TEE.

This application claims the benefit of priority to International Application No. PCT/CN2022/138952, filed Dec. 14, 2022, which is incorporated herein by reference in its entirety.

### BACKGROUND

Cloud native (CN) programming is very rapidly emerging programming and services deployment paradigm that allows seamless scalability across functions, highly distributed deployments, demand-based scaling up/down, deployment agility, using a combination of cloud computing and edge computing concepts. CN has become increasing popular as a way to deploy software application workloads. Confidential Computing generally refers to a category of approaches that provides protection of software services, such as through the use of Trusted Execution Environments (TEEs) and attestation. However, it can be difficult to integrated application workloads with non-virtual machine-based hardware TEEs. In particular, it can be difficult and complex for users to modify applications to adapt to the protection of TEE technologies.

### BRIEF DESCRIPTION OF THE DRAWINGS

FIG. 1 illustrates an overview of an edge cloud configuration for edge computing.

FIG. 2 illustrates deployment of a virtual edge configuration in an edge computing system operated among multiple edge nodes and multiple tenants.

FIG. 3 illustrates various compute arrangements deploying containers in an edge computing system.

FIG. 4 illustrates a general container runtime high-level flow.

FIG. 5 illustrates a high-level flow with a TEE CRI plugin according to some example embodiments.

FIG. 6 illustrates a workflow of application container deployment in a TEE according to some example embodiments.

FIG. 7 illustrates an enclave confidential container workflow.

FIG. 8 illustrates a method for library functionality for operating in a trusted execution environment (TEE) according to some example embodiments.

FIG. 9A provides an overview of example components for compute deployed at a compute node in an edge computing system.

FIG. 9B provides a further overview of example components within a computing device in an edge computing system.

### DETAILED DESCRIPTION

Cloud native (CN) refers to the concept of building and running applications to take advantage of the distributed computing offered by the cloud delivery model. CN applications are designed and built to make use of features and characteristics of the cloud. For example, CN applications can take advantage of the scale, elasticity, resiliency, and flexibility the cloud provides. CN technologies can be implemented in, or provide, features such as containers, service meshes, microservices, immutable infrastructure, and declarative application programming interfaces (APIs). CN has become an industry popular methodology to deploy their software application workloads.

Confidential computing in CN environments allows customers and developers to move privacy sensitive data processing to remote, potentially untrusted systems. The data is sent to and processed in a Trusted Execution Environment (TEE) after attestation, which proves that the runtime environment is legitimate and trusted. Virtual machine-based systems are relatively easy to implement because software can simply be executed in the virtual machine (VM) without modification. However, it can be difficult to integrate application workloads with non-VM-based hardware TEE because applications need to be modified (e.g., application images may need to be rebuilt) to adapt the protection of TEE technologies. Methods, apparatuses, and systems according to various embodiments address these and other concerns by allowing applications to run (or execute) with unmodified images in non-VM-based hardware TEE.

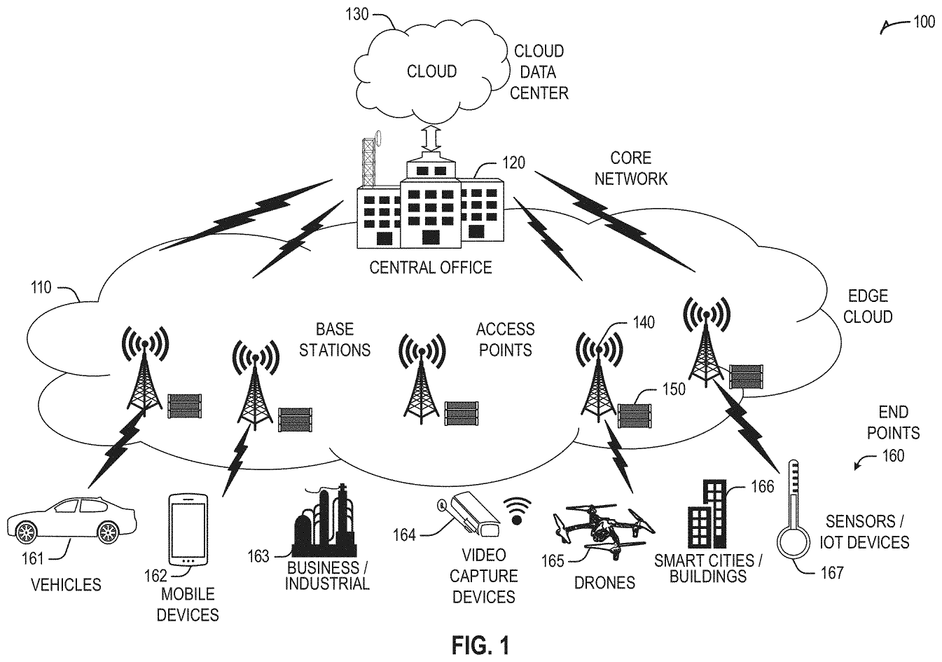

Methods, systems and apparatuses according to embodiments can lead to improvements in computer technology by allowing users to deploy original application workloads in a TEE without having to perform an image rebuild. This reduces the complexity of using computer systems described herein. Users or application developers do not need to take into consideration extraneous host filesystem or package dependencies. FIG. 1-3 illustrates systems in which methods according to example embodiments can be implemented.

### Systems in which Embodiments are Implemented

FIG. 1 is a block diagram 100 showing an overview of a configuration for edge computing, which includes a layer of processing referred to in many of the following examples as an “edge cloud”. As shown, the edge cloud 110 is co-located at an edge location, such as an access point or base station 140, a local processing hub 150, or a central office 120, and thus may include multiple entities, devices, and equipment instances. The edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the edge cloud 110 are critical to providing ultra-low latency response times for services and functions used by the endpoint data sources 160 as well as reduce network backhaul traffic from the edge cloud 110 toward cloud data center 130 thus improving energy consumption and overall network usages among other benefits.

The edge cloud 110 is formed from network components and functional features operated by and within edge gateway nodes, edge aggregation nodes, or other edge compute nodes among network layers 210-230. The edge cloud 110 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 110 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

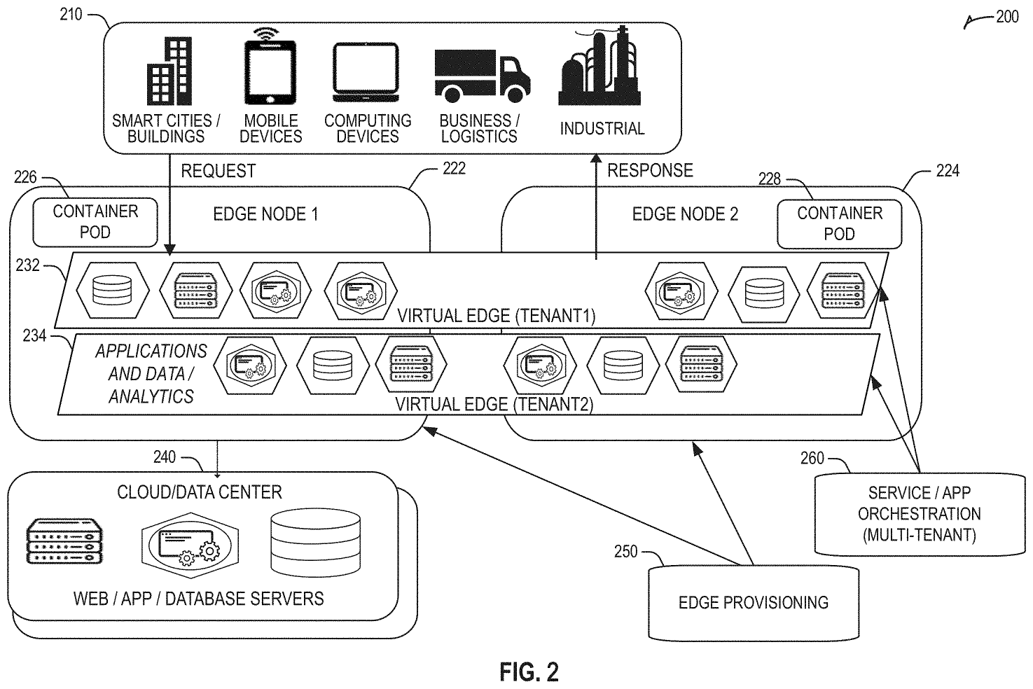

FIG. 2 illustrates deployment and orchestration for virtual edge configurations across an edge computing system operated among multiple edge nodes and multiple tenants. Specifically, FIG. 1 depicts coordination of a first edge node 222 and a second edge node 224 in an edge computing system 200, to fulfill requests and responses for various client endpoints 210 (e.g., smart cities/building systems, mobile devices, computing devices, business/logistics systems, industrial systems, etc.), which access various virtual edge instances. Here, the virtual edge instances 232, 234 provide edge compute capabilities and processing in an edge cloud, with access to a cloud/data center 240 for higher-latency requests for websites, applications, database servers, etc. However, the edge cloud enables coordination of processing among multiple edge nodes for multiple tenants or entities.

In the example of FIG. 2, these virtual edge instances include: a first virtual edge 232, offered to a first tenant (Tenant 1), which offers a first combination of edge storage, computing, and services; and a second virtual edge 234, offering a second combination of edge storage, computing, and services. The virtual edge instances 232, are distributed among the edge nodes 222, 224, and may include scenarios in which a request and response are fulfilled from the same or different edge nodes. The configuration of the edge nodes 222, 224 to operate in a distributed yet coordinated fashion occurs based on edge provisioning functions 250. The functionality of the edge nodes 222, 224 to provide coordinated operation for applications and services, among multiple tenants, occurs based on orchestration functions 260.

It should be understood that some of the various client endpoints in 210 are multi-tenant devices where Tenant 1 may function within a tenant1 ‘slice’ while a Tenant 2 may function within a tenant2 slice (and, in further examples, additional or sub-tenants may exist; and each tenant may even be specifically entitled and transactionally tied to a specific set of features all the way day to specific hardware features). A trusted multi-tenant device may further contain a tenant specific cryptographic key such that the combination of key and slice may be considered a “root of trust” (RoT) or tenant specific RoT. A RoT may further be computed dynamically composed using a DICE (Device Identity Composition Engine) architecture such that a single DICE hardware building block may be used to construct layered trusted computing base contexts for layering of device capabilities (such as a Field Programmable Gate Array (FPGA)). The RoT may further be used for a trusted computing context to enable a “fan-out” that is useful for supporting multi-tenancy. Within a multi-tenant environment, the respective edge nodes 222, 224 may operate as security feature enforcement points for local resources allocated to multiple tenants per node. Additionally, tenant runtime and application execution (e.g., in instances 232, 234) may serve as an enforcement point for a security feature that creates a virtual edge abstraction of resources spanning potentially multiple physical hosting platforms. Finally, the orchestration functions 260 at an orchestration entity may operate as a security feature enforcement point for marshalling resources along tenant boundaries.

Edge computing nodes may partition resources (memory, central processing unit (CPU), graphics processing unit (GPU), interrupt controller, input/output (I/O) controller, memory controller, bus controller, etc.) where respective partitionings may contain a RoT capability and where fan-out and layering according to a DICE model may further be applied to Edge Nodes. Cloud computing nodes consisting of containers, FaaS engines, Servlets, servers, or other computation abstraction may be partitioned according to a DICE layering and fan-out structure to support a RoT context for each. Accordingly, the respective RoTs spanning devices 210, 222, and may coordinate the establishment of a distributed trusted computing base (DTCB) such that a tenant-specific virtual trusted secure channel linking all elements end to end can be established.

Further, it will be understood that a container may have data or workload specific keys protecting its content from a previous edge node. As part of migration of a container, a pod controller at a source edge node may obtain a migration key from a target edge node pod controller where the migration key is used to wrap the container-specific keys. When the container/pod is migrated to the target edge node, the unwrapping key is exposed to the pod controller that then decrypts the wrapped keys. The keys may now be used to perform operations on container specific data. The migration functions may be gated by properly attested edge nodes and pod managers (as described above).

In further examples, an edge computing system is extended to provide for orchestration of multiple applications through the use of containers (a contained, deployable unit of software that provides code and needed dependencies) in a multi-owner, multi-tenant environment. A multi-tenant orchestrator may be used to perform key management, trust anchor management, and other security functions related to the provisioning and lifecycle of the trusted ‘slice’ concept in FIG. 2. For instance, an edge computing system may be configured to fulfill requests and responses for various client endpoints from multiple virtual edge instances (and, from a cloud or remote data center). The use of these virtual edge instances may support multiple tenants and multiple applications (e.g., augmented reality (AR)/virtual reality (VR), enterprise applications, content delivery, gaming, compute offload) simultaneously. Further, there may be multiple types of applications within the virtual edge instances (e.g., normal applications; latency sensitive applications; latency-critical applications; user plane applications; networking applications; etc.). The virtual edge instances may also be spanned across systems of multiple owners at different geographic locations (or, respective computing systems and resources which are co-owned or co-managed by multiple owners).

For instance, each edge node 222, 224 may implement the use of containers, such as with the use of a container “pod” 226, 228 providing a group of one or more containers. In a setting that uses one or more container pods, a pod controller or orchestrator is responsible for local control and orchestration of the containers in the pod. Various edge node resources (e.g., storage, compute, services, depicted with hexagons) provided for the respective edge slices 232, 234 are partitioned according to the needs of each container.

With the use of container pods, a pod controller oversees the partitioning and allocation of containers and resources. The pod controller receives instructions from an orchestrator (e.g., orchestrator 260) that instructs the controller on how best to partition physical resources and for what duration, such as by receiving key performance indicator (KPI) targets based on SLA contracts. The pod controller determines which container requires which resources and for how long in order to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, a pod controller may serve a security role that prevents assignment of resources until the right tenant authenticates or prevents provisioning of data or a workload to a container until an attestation result is satisfied.

Also, with the use of container pods, tenant boundaries can still exist but in the context of each pod of containers. If each tenant specific pod has a tenant specific pod controller, there will be a shared pod controller that consolidates resource allocation requests to avoid typical resource starvation situations. Further controls may be provided to ensure attestation and trustworthiness of the pod and pod controller. For instance, the orchestrator 260 may provision an attestation verification policy to local pod controllers that perform attestation verification. If an attestation satisfies a policy for a first tenant pod controller but not a second tenant pod controller, then the second pod could be migrated to a different edge node that does satisfy it. Alternatively, the first pod may be allowed to execute, and a different shared pod controller is installed and invoked prior to the second pod executing.

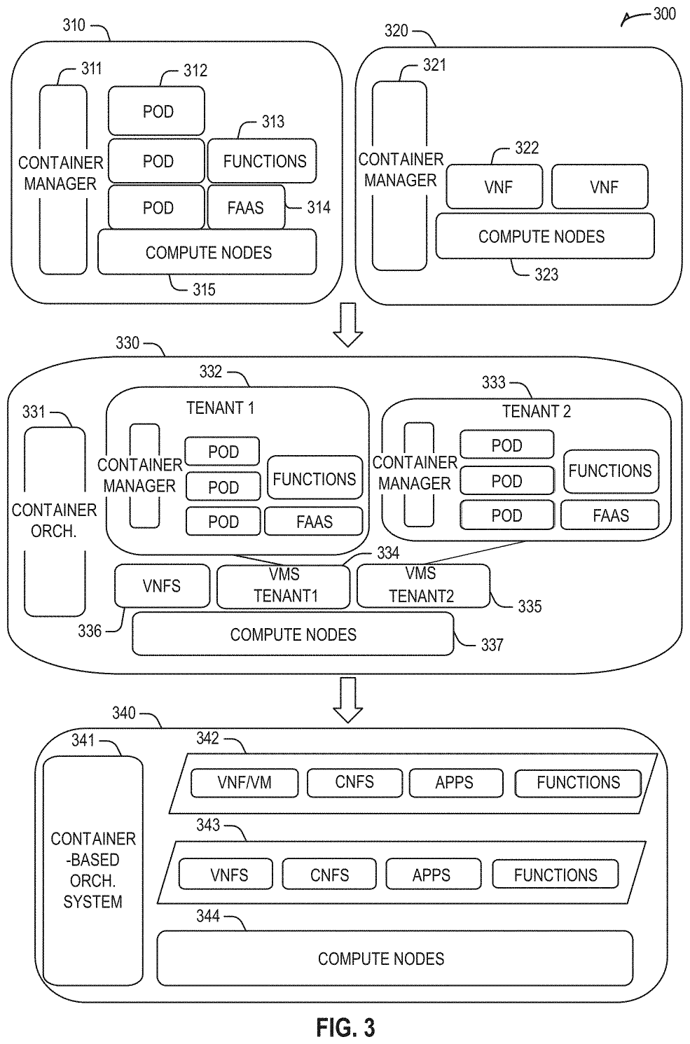

FIG. 3 illustrates additional compute arrangements 300 deploying containers in an edge computing system. As a simplified example, system arrangements 310, 320 depict settings in which a pod controller (e.g., container managers 311, 321, and container orchestrator 331) is adapted to launch containerized pods, functions, and functions-as-a-service instances through execution via compute nodes (315 in arrangement 310), or to separately execute containerized virtualized network functions through execution via compute nodes (323 in arrangement 320). This arrangement is adapted for use of multiple tenants in system arrangement 330 (using compute nodes 336), where containerized pods (e.g., pods 312), functions (e.g., functions 313, VNFs 322, 336), and functions-as-a-service instances (e.g., FaaS instance 314) are launched within virtual machines (e.g., VMs 334, 335 for tenants 332, 333) specific to respective tenants (aside the execution of virtualized network functions). This arrangement is further adapted for use in system arrangement 340, which provides containers 342, 343, or execution of the various functions, applications, and functions on compute nodes 344, as coordinated by a container-based orchestration system 341.

The system arrangements of depicted in FIG. 3 provides an architecture that treats VMs, Containers, and Functions equally in terms of application composition (and resulting applications are combinations of these three ingredients). Each ingredient may involve use of one or more accelerator (FPGA, ASIC) components as a local backend. In this manner, applications can be split across multiple edge owners, coordinated by an orchestrator.

In the context of FIG. 3 the pod controller/container manager, container orchestrator, and individual nodes may provide a security enforcement point. However, tenant isolation may be orchestrated where the resources allocated to a tenant are distinct from resources allocated to a second tenant, but edge owners cooperate to ensure resource allocations are not shared across tenant boundaries. Or, resource allocations could be isolated across tenant boundaries, as tenants could allow “use” via a subscription or transaction/contract basis. In these contexts, virtualization, containerization, enclaves and hardware partitioning schemes may be used by edge owners to enforce tenancy. Other isolation environments may include: bare metal (dedicated) equipment, virtual machines, containers, virtual machines on containers, or combinations thereof.

In further examples, aspects of software-defined or controlled silicon hardware, and other configurable hardware, may integrate with the applications, functions, and services an edge computing system. Software defined silicon may be used to ensure the ability for some resource or hardware ingredient to fulfill a contract or service level agreement, based on the ingredient's ability to remediate a portion of itself or the workload (e.g., by an upgrade, reconfiguration, or provision of new features within the hardware configuration itself).

### Application Orchestration in Trusted Execution Environments

As briefly mentioned earlier herein, confidential computing in CN environments allows customers and developers to move privacy sensitive data processing to remote, potentially untrusted systems. The data is sent to and processed in a TEE after attestation, which proves that the runtime environment is legitimate and trusted. VM-based systems are relatively easy to implement because software can simply be executed in the VM without modification. However, it can be difficult to integrate application workloads with non-VM-based hardware TEE because applications need to be modified to adapt the protection of TEE technologies. Available systems addressed these concerns by allowing users to run unmodified container image in encrypted regions, sometimes referred to as “enclaves.” With enclaves or similar technologies, users can generate new container images without changing the original application code. Users can use specific library operating system tools or commands to rebuild the original application image. However, these available systems still use a new container image built to wrap the library operating system artifacts on top of the original image, leading to at least double amount of the original storage space to store each application. Furthermore, for sensitive applications, the rebuild job should run on a customer's TEE, meaning that customers need to have library operating system artifacts and library dependencies present in the customer environment beforehand. The new image may also have extraneous dependencies, e.g., unnecessary Docker dependencies, scripts execution environment dependencies, root execution authority dependencies, etc. These and other limitations can add to transfer of information (TOI) efforts and increase the supply chain burden and the deployment complexity. Finally, some available solutions can require other pre-installed packages or software to available on the host including, for example open container initiative (OCI) bundle dependencies.

In still other available solutions, the limitation of the traditional network stack can be partially overcome by remote direct memory access (RDMA) solutions, in which NIC hardware can exchange data directly between the memory space of applications running on different compute nodes. With RDMA solutions, the data transmission can be triggered directly by the application. Protocol encapsulation/decapsulation and memory transfer can be performed by hardware, reducing or eliminating the need of a kernel mode software stack. However, available RDMA solutions focus on delivering data as fast as possible, rather than in a pre-defined time or time slot. Further, use of RDMA may result in bursts, buffer overflows and non-optimal usage of the network as well as unpredicted behavior of time-sensitive applications.

Methods, apparatuses, and systems according to various embodiments address these and other concerns by allowing applications to run (or execute) with unmodified images in non-VM-based hardware TEE. Example embodiments provide a TEE library operating system (OS) layer that includes the artifacts and configurations needed for the Library OS. In the context of embodiments described herein, a Library OS refers to a program execution environment operating in a TEE and may be regarded as a container having an input/output interface and containing a plurality of sub programs. A Library OS can include various components such as an interface (which can include communications services), handlers to handle function calls, trusted computing programs, key management, encryption and decryption, etc.

The TEE Library OS layer can be added as an overlay mount on top of the application container rootfs layer in a container runtime as described later herein. In the context of embodiments, an overlay can include a type of system for use in file systems, in which multiple folders are virtually merged while keeping folder contents separate. An overlay file system, or layered file system, contains one or more layers of folders, the topmost being read/write, and the lower layers read-only.

Some overlay file systems can be further be considered to be mounting mechanisms or to perform some functionalities of mounting mechanisms. Some example embodiments can use or be based on OverlayFS, which is a union mount filesystem that combines multiple mount points into one. The result of this combination can comprise a single directory structure that contains underlying files and sub-directories from multiple systems. In some examples, temporary modification of read-only files or folders can be allowed.

The TEE Library OS layer related artifacts can be universal for applications and can be prepared and published once and used anywhere. The configurations can application specific and can be defined by the application owner in deployment phase.

Both the artifacts and configurations can be defined as OCI artifacts and be distributed separately in a container registry (e.g., repository). In the context of embodiments, an OCI container image or simply a “container image”) can contain a product (e.g., a software product) that is to be run within a container. Images can be stored in and downloaded from a registry, or OCI registry, wherein this registry can provide secured storage services. Further in the context of embodiments, an OCI artifact can be understood as a container for a product that is stored as a non-image type within an OCI registry).

Embodiments of this disclosure relate to aspects of container runtime behavior and provide an architecture and workflow for software application supply chain publication and deployment. Aspects of various embodiments can leverage Library OS technologies, which are not applicable for VM-based TEEs and, accordingly, the description provided herein relates to non-VM-based TEE. In example embodiments described herein, a container is used to provide an environment in which function code is executed. The container may be any isolated-execution entity such as a process, a Docker or Kubernetes container.

Four roles are used and implemented in example embodiments described herein. A first role includes the role of TEE vendor. In the context of example embodiments, a TEE vendor (TV) provides processor (e.g., host or central processing unit (CPU)) products that include enclave and TEE features. The TV can further provide software development kits (SDKs) and drivers to be used by Library OS technologies.

A second role is the role of a customer. In the context of example embodiments, customers can be Independent Software Vendors (ISV) or software developers who leverage cloud service provider services to publish application workloads for business and/or academic use. Customers may have security concerns within the scope of example embodiments, and customers may prefer to run their applications in CN TEE capable clusters.

A third role is that of a Cloud Service Provider (CSP). CSPs provide clusters for cloud native application deployment and provisioning, some of which can be TEE capable. Most currently-operating CSPs (e.g., Amazon, Microsoft, Google, Alibaba, etc.) provide container registry services to host various software artifacts compliant with the Open Container Initiative (OCI) specifications. CSPs may also use public container registry services such as docker.io, quay.io, etc.

A fourth role can include that of a TEE Library OS Solution Provider (LSP). Some typical Library OS technologies can include Gramine and Occlum in cases in which Intel® Software Guard Extensions (SGX) is used) or other technologies for use with other enclave-type systems. Some Library OS technologies can be open source. Other enclave-type systems can include TEE's based built using Keystone, based on RISC-V, an open standard instruction set architecture

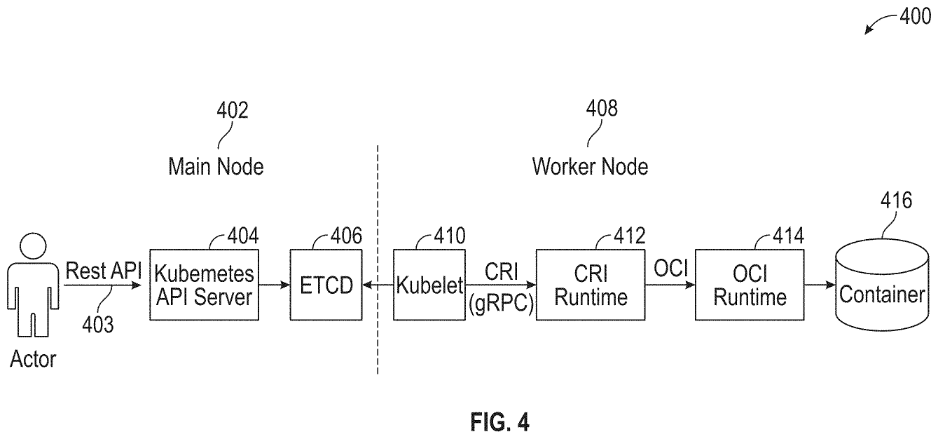

FIG. 4 illustrates a general container runtime high-level flow 400. Referring to FIG. 4, a main node 402 (according to, for example, a Kubernetes architecture) can implement an API server 404 to validate and configure data for API objects including pods, services, etc. A fabric 403 is provided over which external user commands are input to the API server 404. The main node 402 can also implement an etcd 406, which can implement a distributed key-value store for data of a distributed system including the main node 402 and worker node 404 as well as any other nodes or devices. The main node 402 can perform other functionalities or have other components not shown in FIG. 4, and embodiments are not limited to the components shown in FIG. 4.

A worker node 408 can implement a kubelet 410, wherein the kubelet 410 can execute on each node in a distributed system to assist and ensure that each container runs in a pod. The worker node 408 can implement a container runtime interface (CRI) 412 to handle Kubernetes CRI gRPC request and provides various image services and container lifecycle management. In the context of example embodiments, gRPC can be understood to be a protocol for communication between kubelet 410 and CRI runtime 412. CRI runtime can be regarded as a high-level runtime. OCI runtime 414 can be regarded as low-level runtime and can deal with OCI related requests. OCI runtime 414 can be responsible for creating and running sandbox and application containers 416.

In some available container deployment scenarios, the CRI runtime 412 can provide an image service, using an example workflow as follows. First, the CRI runtime 412 can pull an application image from a container registry. The CRI runtime can unpack application image into an OCI bundle and decrypt the image layers if needed. In the context of embodiments, a “bundle” or an “OCI bundle” is (or can include) a “tarball” structure having a root at the root filesystem and includes binary files or other files that comprise a workload to be executed.

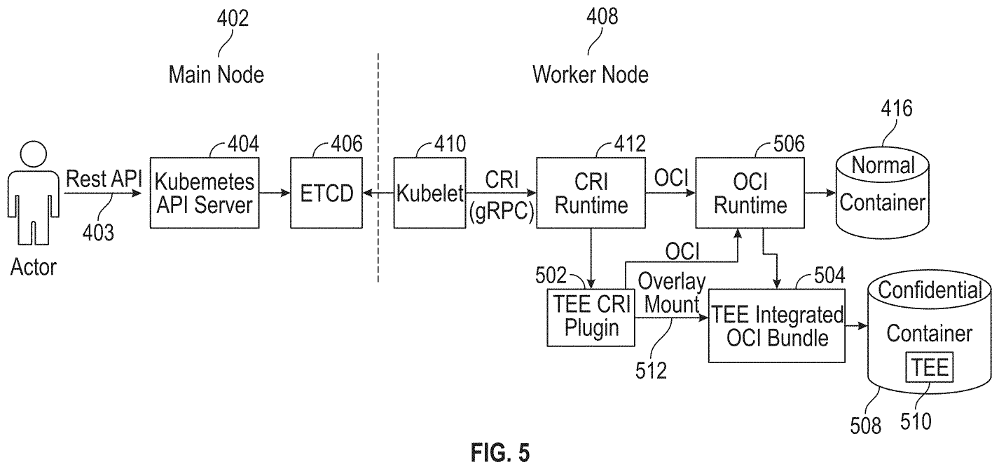

The CRI runtime 412 can call an OCI runtime 414 binary to create the sandbox container 416; setup cgroups, wherein a cgroup is a Linux kernel capability that establishes resource management functionality such as CPU usage limiting, memory limits, etc.; namespaces, etc. The CRI runtime 412 can call an OCI runtime binary to launch the OCI bundle as an application container. If the application image is to be executed in a TEE, according to embodiments, a TEE CRI plugin module is defined as shown in FIG. 5.

FIG. 5 illustrates a high-level flow with a TEE CRI plugin according to some example embodiments. In FIG. 5, a TEE deployment scenario can define a TEE CRI Plugin 502. The TEE CRI Plugin 502 can operate to offload at least some of the above-described image service jobs from the CRI runtime 412, including but not limited to, for example, image pulling, unpacking, decryption (for confidential container scenarios in particular), storage, etc. The TEE CRI Plugin 502 can generate a TEE Integrated OCI bundle 504 using overlay mount technology.

The OCI Runtime 506 can run the bundle by, e.g., creating a sandbox container 416 first, and then creating the confidential application container 508. Because the bundle has integrated Library OS specific artifacts, the OCI runtime 506 can create a TEE 510 inside the application container 508, decrypt the encrypted layers in the TEE 510, and run original workloads inside the container 508. Depending on configuration settings provided by the user, the application, or other component, workloads can be run inside a non-confidential container (not shown in FIG. 5).

The CRI Runtime 412 can support both the scenario depicted in FIG. 4 and scenarios described above with respect to the TEE CRI plugin 502, etc. simultaneously, with the actual workflow path being controlled by CRI Runtime configuration. Embodiments described herein can a Kubernetes Operator pattern, wherein an Operator in this context can include a software extension that makes use of custom resource to manage applications and application components. In general, the Operator pattern can allow for deploying of an application on demand, taking and restoring backups of that application's state, handling upgrades, publishing services, and other operations and functions. Embodiments provide an operator, patterned after the Kubernetes Operator pattern, which defines a customer resource (CR) referred to hereinafter as TEE-Runtime. LSP general and configuration parameters can be defined within a Custom Resource Definition (CRD) of this CR. The LSP-provided tools can be integrated into the CR instance controller to fetch TEE-specific configurations and generate Library OS specific artifacts for the overlay mount 512.

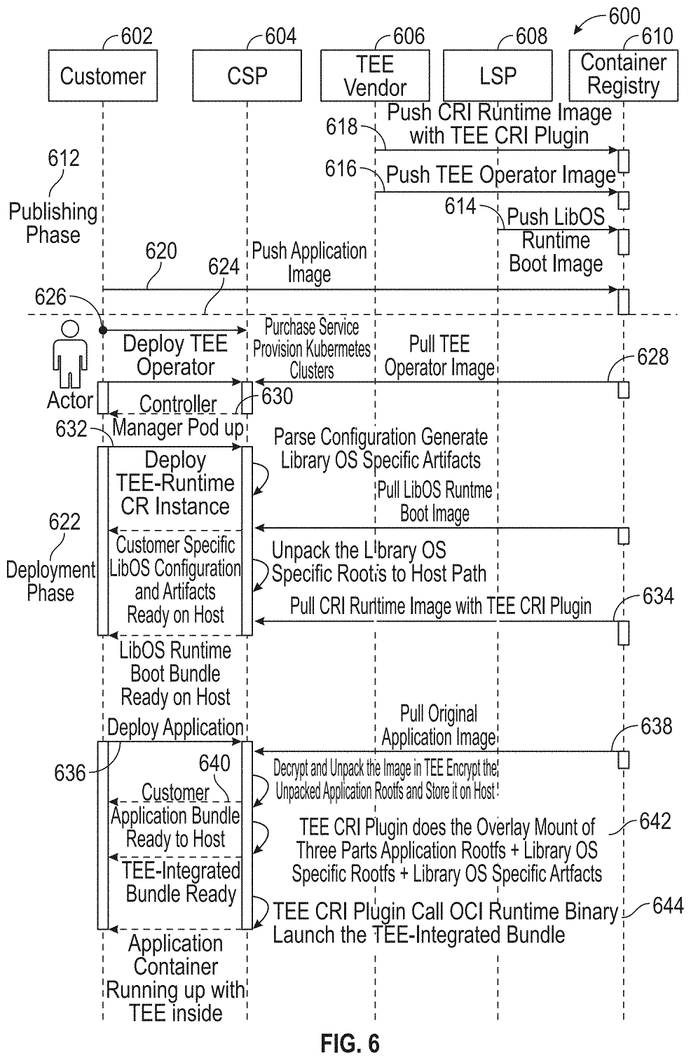

FIG. 6 illustrates a workflow 600 of application container deployment in a TEE according to some embodiments. A customer 602, Cloud Service Provider (CSP) 604, TEE Vendor 606, and LSP 608 (which were defined above as second, third, first, and fourth roles, respectively) perform functions in the workflow 600. A container registry 610 can be provided by the CSP 604 and was also described earlier herein as providing a repository to store and access container images.

In a Publishing Phase 612, the TEE vendor 606 and/or LSP 608 may publish specific artifacts images, previous to the other operations, at least because the artifact images are application-agnostic and other functionalities within the workflow 600 will not be negatively or otherwise impacted by the presence of such application-agnostic images. For example, at operation 614, the LSP 608 may push specific Runtime Boot images into the container registry 610. The Runtime Boot image builds with the Library OS packages and libraries needed for subsequent operations. Furthermore, because Runtime Boot images are application agnostic, the Runtime Boot images can be built once and used in more than one location, e.g., in any location in the systems described herein. Similarly, at operation 616, the TEE vendor 606 and/or LSP 608 can push the TEE Operator image into container registry 610. Furthermore, at operation 618, the TEE Vendor 606 or LSP 607 can push the TEE CRI Plugin 502 associated CRI Runtime image into the container registry 610. At operation 620, customers 602 can publish original application container images into the container registry 610.

In a Deployment Phase 622, a customer 602 can purchase a CSP 604 service at 624, and TEE-capable Kubemetes clusters can be deployed to application workloads. A customer 602 using, e.g., Kubemetes can use tools such as command line tools (e.g., kubectl) to deploy application components at 626. At operation 628, a TEE Operator image can be pulled and deployed. In operation 628, the operator image will be pulled from the container registry 610, and the TEE specific tools for parsing configuration and generating artifacts can be integrated into CR controller in this image. An operator controller manager pod can be established at 630.

At operation 632, a customer specific TEE-Runtime CR instance can be deployed. In operation 632, the CR instance parameters can be parsed by the CR controller, the TEE specific runtime class can be created, the specific CRI Runtime image with TEE CRI Plugin 502 (FIG. 5) can be pulled at operation 634, and the TEE plugin 502 (FIG. 5) can be configured properly for the CRI Runtime 412 (FIG. 4 and FIG. 5).

In operation 636, the customer 602 application can be deployed. Starting with operation 636, the TEE CRI Plugin 502 can initiate application image lifecycle management. For example, the TEE CRI Plugin 502 can pull the application image from registry at operation 638 and unpack the image to create an OCI bundle (see e.g., OCI bundle 504 (FIG. 5)). For encrypted application images, such jobs should happen in a TEE created by TEE CRI Plugin 502, and the unpacked application rootfs should be encrypted again and stored on a host at operation 640.

At operation 642, the TEE CRI Plugin 502 can check if the LSP Runtime Boot bundle exists on a target cluster node specific path. If no, the TEE CRI Plugin can pull the LSP Runtime Boot image from the container registry and unpack the LSP Runtime Boot image to a host as a Library OS specific rootfs. Otherwise, if the LSP Runtime Boot bundle does exist on the target cluster node specific path, the TEE CRI Plugin 502 can overlay mount three parts at operation 642. A first part can include the application rootfs, a second part can include the Library OS specific rootfs, and a third part can include Library OS specific artifacts generated by the Kubernetes Operator TEE-Runtime CR controller. The new overlayed bundle can be referred to as a called TEE-integrated bundle. For an encrypted application image scenario, the TEE-integrated bundle can also wrap the decrypt key for the encrypted application rootfs, wherein the key provision mechanism follows an appropriate attestation process. At operation 644, the TEE CRI Plugin 502 can call an OCI Runtime binary to create a sandbox and launch the TEE-integrated bundle.

Using the above operation described with reference to FIG. 6, in a field deployment, customers 602 can directly use an original application container image and other components of the system described, e.g., with reference to FIG. 4-6, can define the secured runtime environment, and generate and run the TEE capable OCI bundle under Docker-less/non-root scenarios.

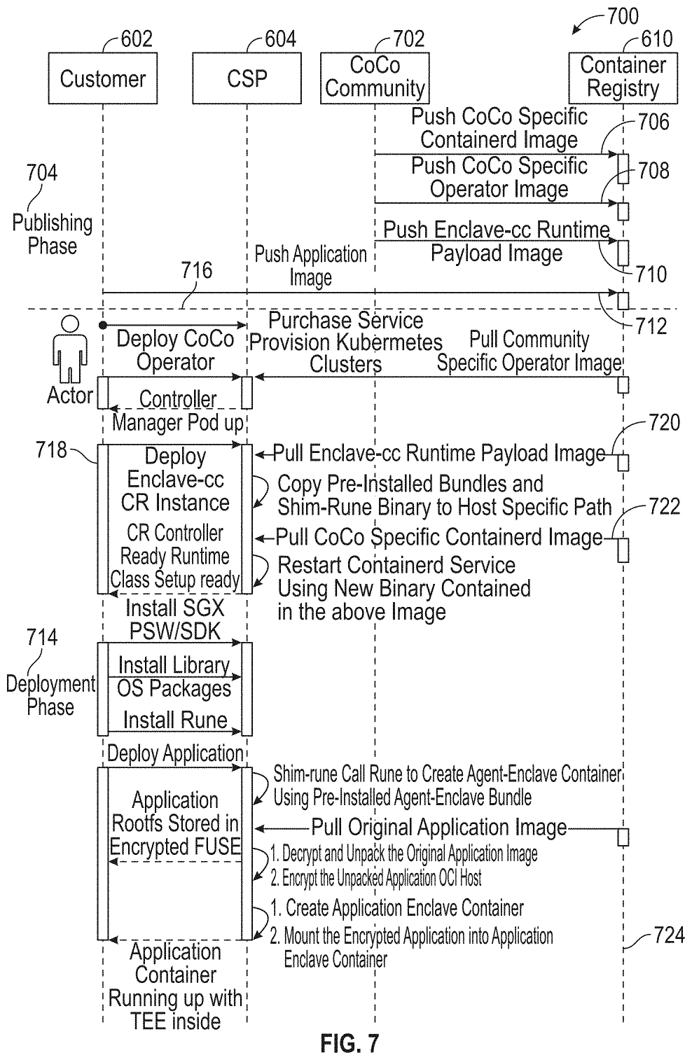

Other enclave software and systems can include a sub-project of Confidential Containers (e.g., “CoCo”). A CoCo workflow 700 is shown in FIG. 7. In the depiction shown in FIG. 7, TEE vendor and LSP are replaced by a CoCo component 702.

The workflow 700 and CoCo itself can provide some similar operations as those shown in FIG. 6. For example, enclave-cc also follows a Kubernetes Operator pattern to deploy an application, using a “CoCo specific Operator” similarly to the “TEE Operator” of FIG. 6. An “enclave-cc CR instance” is defined similarly to a “TEE-Runtime CR instance.”

Similarly to the workflow 600, the workflow 700 can provide a Publishing Phase 704. CoCo supports “containerd” as a CRI Runtime, and “CoCo specific containerd image” is supported for image service operations “offloading.” The containerd image can be pushed to the registry 610 in operation 706 and at operation 708, a CoCo specific operator image can be pushed into container registry 610.

The “enclave-cc runtime payload image” includes the functionalities similar to “LibOS Runtime Boot image,” but also wraps other artifacts for runtime deployment use. The “enclave-cc runtime payload image” is statically built to wrap two pre-installed OCI bundles (“agent-enclave bundle” and “boot instance bundle”) and a “shim-rune” binary. These are copied from a payload image container at operation 710 to the host in runtime deployment and work together to implement similar functionalities to the TEE CRI Plugin 502 described above. At operation 712, customers 602 can publish original application container images into the container registry 610.

In a Deployment Phase 714, a customer 602 can purchase a CSP 604 service at 716, and CoCo-capable Kubernetes clusters can be deployed to application workloads. At operation 718, an enclave-cc instance is deployed. At operation 720, an enclave-cc runtime payload image can be pulled and deployed. The enclave-cc runtime payload image will be pulled from the container registry 610. In contrast to embodiments of the present disclosure, the enclave-cc solution provides Library OS specific configurations that are statically built into the two pre-installed OCI bundles at operation 722. Accordingly, customers cannot adjust parameters in the whole container runtime lifecycle. In further contrast to example embodiments, in enclave-cc, there is a specific OCI runtime binary “rune” that must be present on the host, along with any dependencies for that binary. Installation efforts are therefore increased in enclave-cc solutions relative to example embodiments of the present disclosure. The “shim-rune” will use “rune” to create an empty application enclave container first, then mount the encrypted application rootfs into the enclave and decrypt there.

Finally, enclave-cc provides a similar user experience as available containers. In example embodiments of the present disclosure, there is only one standard OCI bundle called “TEE-integrated bundle”, and a standard OCI Runtime can run this bundle as a normal container. TEE and Library OS details are organized by the bundle itself and customers do not need to be aware of details. In contrast, in enclave-cc, there are two pre-installed OCI bundles on host, the trusted storage solution of unpacked application rootfs on host can be Library OS specific. The final mount mechanism 724 of encrypted application rootfs into the application enclave is also Library OS specific. Customers need to expend additional efforts and consideration regarding the Library OS choice. Accordingly, flexibility and ease of use is seen to be enhanced in example embodiments relative to CoCo-based embodiments.

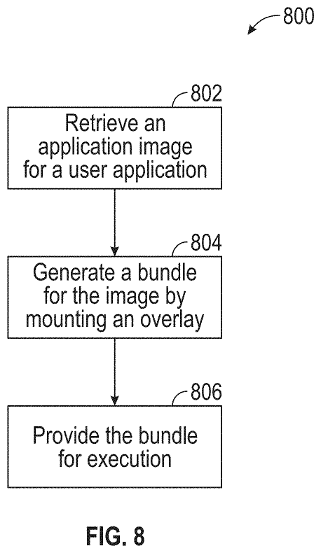

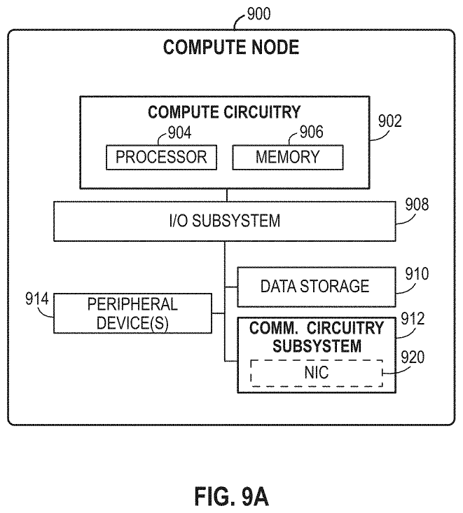

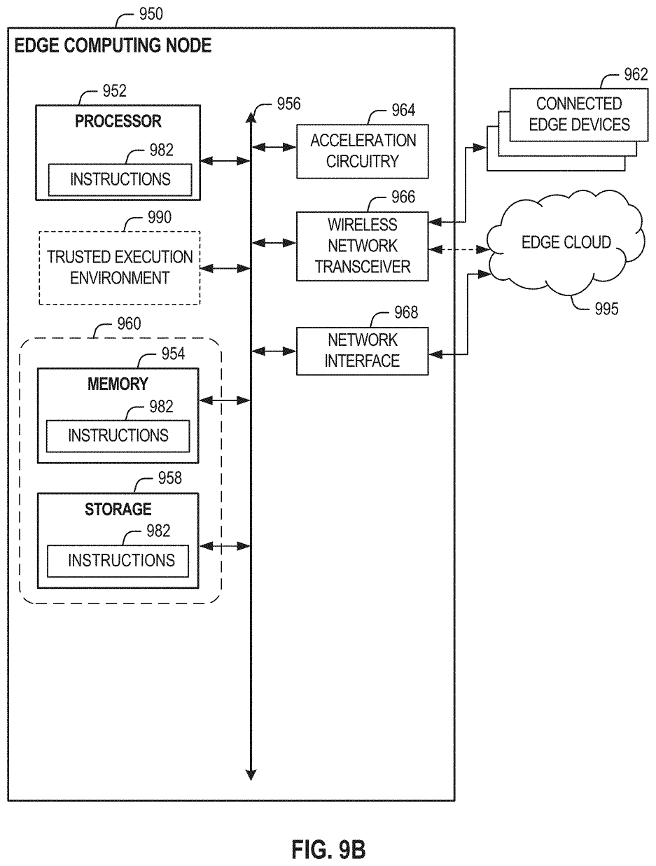

FIG. 8 illustrates a method 800 for library functionality for operating in a trusted execution environment (TEE) according to some example embodiments. The method 800 can be implemented by components of user devices, e.g., user computing nodes, CSP devices, TEE vendor components, etc., as shown in FIG. 6 or in any of the components of FIG. 9A-9B. The TEE can comprise a process-based TEE and the TEE can be launched inside or outside of a virtual machine (VM) environment.

The method 800 can begin with operation 802 with retrieving a user application image. Operation 802 can be performed according to, for example, operation 628 (FIG. 6) or as discussed regarding CRI runtime 412 (FIG. 4 and FIG. 5) on a worker node 408.

The method 800 can continue with operation 804 with generating a bundle for the application image by mounting an overlay onto the application image. As described above, the overlay can include library functionality for operating in a trusted execution environment (TEE). Operation 804 can be performed by, for example, TEE CRI plugin 502 (FIG. 5) to generated TEE integrated OCI bundle 504 (FIG. 5).

The method 800 can continue with operation 806 with providing the bundle for execution in the TEE. As described earlier herein with respect to operations 614, and 618, the operations of method 800 can further include providing runtime environment-agnostic images to a container registry (e.g., container registry 610). Further, bundling operations of operation 804 can include, by way of nonlimiting example, image service operations including one or more of an image pulling operation (e.g., operation 628 (FIG. 6)), a decryption operation, an unpacking operation, and a bundling operation.

The methods, systems and apparatuses described above can use existing container overlay file system patterns to overlay TEE-related settings, data, etc. at runtime or near to runtime, on an as-needed basis, based on user settings, configurations, and specification. Accordingly, examples according to embodiments can provide a quick and efficient way for users and application developers to execute applications in a non-VM based hardware TEE, without affecting or otherwise slowing VM-based solutions and application development.

### Other Apparatuses

In further examples, any of the compute nodes or devices discussed with reference to the present edge computing systems and environment may be fulfilled based on the components depicted in FIGS. 9A and 9B. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions. In the simplified example depicted in FIG. 9A, an edge compute node 900 includes a compute engine (also referred to herein as “compute circuitry”) 902, an input/output (I/O) subsystem 908, data storage 910, a communication circuitry subsystem 912, and, optionally, one or more peripheral devices 914. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 900 may be embodied as any type of engine, device, or collection of devices capable of performing various compute functions. In some examples, the compute node 900 may be embodied as a single device such as an integrated circuit, an embedded system, a field-programmable gate array (FPGA), a system-on-a-chip (SOC), or other integrated system or device. In the illustrative example, the compute node 900 includes or is embodied as a processor 904 and a memory 906. The processor 904 may be embodied as any type of processor capable of performing the functions described herein (e.g., executing an application). For example, the processor 904 may be embodied as a multi-core processor(s), a microcontroller, or other processor or processing/controlling circuit. In some examples, the processor 904 may be embodied as, include, or be coupled to an FPGA, an application specific integrated circuit (ASIC), reconfigurable hardware or hardware circuitry, or other specialized hardware to facilitate performance of the functions described herein.

The compute circuitry 902 is communicatively coupled to other components of the compute node 900 via the I/O subsystem 908, which may be embodied as circuitry and/or components to facilitate input/output operations with the compute circuitry 902 (e.g., with the processor 904 and/or the main memory 906) and other components of the compute circuitry 902. The one or more illustrative data storage devices 910 may be embodied as any type of devices configured for short-term or long-term storage of data.

The communication circuitry 912 may be embodied as any communication circuit, device, or collection thereof, capable of enabling communications over a network between the compute circuitry 902 and another compute device (e.g., an edge gateway of an implementing edge computing system). The communication circuitry may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 912 includes a network interface controller (NIC) 920, which may also be referred to as a host fabric interface (HFI). The NIC 920 may be embodied as one or more add-in-boards, daughter cards, network interface cards, controller chips, chipsets, or other devices that may be used by the compute node 900 to connect with another compute device (e.g., an edge gateway node). In some examples, the NIC 920 may be embodied as part of a system-on-a-chip (SoC) that includes one or more processors or included on a multichip package that also contains one or more processors. In some examples, the NIC 920 may include a local processor (not shown) and/or a local memory (not shown) that are both local to the NIC 920. In such examples, the local processor of the NIC 920 may be capable of performing one or more of the functions of the compute circuitry 902 described herein. Additionally, or alternatively, in such examples, the local memory of the NIC 920 may be integrated into one or more components of the client compute node at the board level, socket level, chip level, and/or other levels.

In a more detailed example, FIG. 9B illustrates a block diagram of an example of components that may be present in an edge computing node 950 for implementing the techniques (e.g., operations, processes, methods, and methodologies) described herein. This edge computing node 950 provides a closer view of the respective components of node 900 when implemented as or as part of a computing device (e.g., as a mobile device, a base station, server, gateway, etc.). The edge computing node 950 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 950, or as components otherwise incorporated within a chassis of a larger system.

The edge computing device 950 may include processing circuitry in the form of a processor 952, which may be a microprocessor, a multi-core processor, a multithreaded processor, an ultra-low voltage processor, an embedded processor, or other known processing elements. The processor 952 may be a part of a system on a chip (SoC) in which the processor 952 and other components are formed into a single integrated circuit, or a single package, such as the Edison™ or Galileo™ SoC boards from Intel Corporation, Santa Clara, Calif. As an example, the processor 952 may include an Intel® Architecture Core™ based CPU processor, such as a Quark™ an Atom™, an i3, an i5, an i7, an i9, or an MCU-class processor, or another such processor available from Intel®. However, any number other processors may be used, such as available from Advanced Micro Devices, Inc. (AMD®) of Sunnyvale, Calif., a MIPS®-based design from MIPS Technologies, Inc. of Sunnyvale, Calif., an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 952 and accompanying circuitry may be provided in a single socket form factor, multiple socket form factor, or a variety of other formats, including in limited hardware configurations or configurations that include fewer than all elements shown in FIG. 9B.

The processor 952 may communicate with a system memory 954 over an interconnect 956 (e.g., a bus). Any number of memory devices may be used to provide for a given amount of system memory. To provide for persistent storage of information such as data, applications, operating systems and so forth, a storage 958 may also couple to the processor 952 via the interconnect 956.

The components may communicate over the interconnect 956. The interconnect 956 may include any number of technologies, including industry standard architecture (ISA), extended ISA (EISA), peripheral component interconnect (PCI), peripheral component interconnect extended (PCIx), PCI express (PCIe), or any number of other technologies. The interconnect 956 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 956 may couple the processor 952 to a transceiver 966, for communications with the connected edge devices 962. The wireless network transceiver 966 (or multiple transceivers) may communicate using multiple standards or radios for communications at a different range.

The edge computing node 950 may include or be coupled to acceleration circuitry 964, which may be embodied by one or more artificial intelligence (AI) accelerators, a neural compute stick, neuromorphic hardware, an FPGA, an arrangement of GPUs, an arrangement of data processing units (DPUs) or Infrastructure Processing Units (IPUs), one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like.

The storage 958 may include instructions 982 in the form of software, firmware, or hardware commands to implement the techniques described herein. Although such instructions 982 are shown as code blocks included in the memory 954 and the storage 958, it may be understood that any of the code blocks may be replaced with hardwired circuits, for example, built into an application specific integrated circuit (ASIC). A network interface 968 can provide connectivity to an edge cloud similarly to that described above with reference to edge cloud 110 (FIG. 1).

In an example, the instructions 982 provided via the memory 954, the storage 958, or the processor 952 may be embodied as a non-transitory, machine-readable medium 960 including code to direct the processor 952 to perform electronic operations in the edge computing node 950. The processor 952 may access the non-transitory, machine-readable medium 960 over the interconnect 956. For instance, the non-transitory, machine-readable medium 960 may be embodied by devices described for the storage 958 or may include specific storage units such as optical disks, flash drives, or any number of other hardware devices. The non-transitory, machine-readable medium 960 may include instructions to direct the processor 952 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 982 on the processor 952 (separately, or in combination with the instructions 982 of the machine readable medium 960) may configure execution or operation of a trusted execution environment (TEE) 990. In an example, the TEE 990 operates as a protected area accessible to the processor 952 for secure execution of instructions and secure access to data. Various implementations of the TEE 990, and an accompanying secure area in the processor 952 or the memory 954 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 950 through the TEE 990 and the processor 952.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., Hypertext Transfer Protocol (HTTP)).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

### ADDITIONAL NOTES AND ASPECTS

Example 1 is a computer-readable medium including instructions that, when executed on a processor, cause the processor to perform operations including: retrieving an application image; generating a bundle for the application image by mounting an overlay onto the application image, the overlay including library functionality for operating in a trusted execution environment (TEE); and providing the bundle for execution in the TEE.

In Example 2, the subject matter of Example 1 can optionally include wherein the operations include determining whether to execute the bundle within a confidential container or a non-confidential container based on configuration settings corresponding to the application image.

In Example 3, the subject matter of any of Examples 1-2 can optionally include wherein the operations include providing runtime environment-agnostic images to a container registry.

In Example 4, the subject matter of any of Examples 1-3 can optionally include wherein generating the bundle includes performing image service operations.

In Example 5, the subject matter of Example 4 can optionally include wherein the image service operations include at least one of an image pulling operation, a decryption operation, an unpacking operation, and a bundling operation.

In Example 6, the subject matter of Example 5 can optionally include wherein the operations further include parsing an application configuration and generating artifacts specific to a program execution environment operating in the TEE.

In Example 7, the subject matter of any of Examples 1-6 can optionally include wherein the operations are executed inside a virtual machine (VM) environment.

In Example 8, the subject matter of any of Examples 1-7 can optionally include wherein the application image is in an open container initiative (OCI) format.

Example 9 is a method for executing an application in a trusted execution environment (TEE), the method comprising: retrieving an application image; generating a bundle for the application image by mounting an overlay onto the application image, the overlay including library functionality for operating in a trusted execution environment (TEE); and providing the bundle for execution in the TEE.

In Example 10, the subject matter of Example 9 can optionally include wherein the TEE comprises a process-based TEE and wherein the TEE is launched outside of a virtual machine (VM) environment.

In Example 11, the subject matter of any of Examples 9-10 can optionally include wherein the TEE comprises a process-based TEE and wherein the TEE is launched inside of a virtual machine (VM) environment.

In Example 12, the subject matter of any of Examples 9-11 can optionally include providing runtime environment-agnostic images to a container registry.

In Example 13, the subject matter of any of Examples 9-12 can optionally include wherein generating the bundle includes performing image service operations comprising at least one of an image pulling operation, a decryption operation, an unpacking operation, and a bundling operation.

In Example 14, the subject matter of any of Examples 9-13 can optionally include parsing an application configuration and generating artifacts specific to a program execution environment operating in the TEE.

Example 15 is a computing node operating outside a virtual machine environment and including processing circuitry configured to perform operations comprising: retrieving an application image; generating a bundle for the application image by mounting an overlay onto the application image, the overlay including library functionality for operating in a trusted execution environment (TEE); and providing the bundle for execution in the TEE.

In Example 16, the subject matter of Example 15 can optionally include wherein the TEE comprises a process-based TEE and wherein the TEE is launched outside of a virtual machine (VM) environment.

In Example 17, the subject matter of any of Examples 15-16 can optionally include wherein the TEE comprises a process-based TEE and wherein the TEE is launched inside of a virtual machine (VM) environment.

In Example 18, the subject matter of any of Examples 15-17 can optionally include wherein the operations include determining whether to execute the bundle within a confidential container or a non-confidential container based on configuration settings corresponding to the application image.

The above detailed description includes references to the accompanying drawings, which form a part of the detailed description. The drawings show, by way of illustration, specific aspects in which the invention can be practiced. These aspects are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other aspects can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed aspect. Thus, the following claims are hereby incorporated into the Detailed Description, with each claim standing on its own as a separate aspect, and it is contemplated that such aspects can be combined with each other in various combinations or permutations. The scope of the invention should be determined with reference to the appended claims, along with the full scope of equivalents to which such claims are legally entitled.

We claim:

1. A computer-readable medium including instructions that, when executed on a processor, cause the processor to perform operations including:
retrieving an application image;
generating a bundle for the application image by mounting an overlay onto the application image, the overlay including library functionality for operating in a trusted execution environment (TEE); and
providing the bundle for execution in the TEE.

2. The computer-readable medium of claim 1, wherein the operations include determining whether to execute the bundle within a confidential container or a non-confidential container based on configuration settings corresponding to the application image.

3. The computer-readable medium of claim 1, wherein the operations include providing runtime environment-agnostic images to a container registry.

4. The computer-readable medium of claim 1, wherein generating the bundle includes performing image service operations.

5. The computer-readable medium of claim 4, wherein the image service operations include at least one of an image pulling operation, a decryption operation, an unpacking operation, and a bundling operation.

6. The computer-readable medium of claim 1, wherein the operations further include parsing an application configuration and generating artifacts specific to a program execution environment operating in the TEE.

7. The computer-readable medium of claim 1, wherein the operations are executed inside a virtual machine (VM) environment.

8. The computer-readable medium of claim 1, wherein the application image is in an open container initiative (OCI) format.

9. A method for executing an application in a trusted execution environment (TEE), the method comprising:
retrieving an application image;
generating a bundle for the application image by mounting an overlay onto the application image, the overlay including library functionality for operating in a trusted execution environment (TEE); and
providing the bundle for execution in the TEE.

10. The method of claim 9, wherein the TEE comprises a process-based TEE and wherein the TEE is launched outside of a virtual machine (VM) environment.

11. The method of claim 9, wherein the TEE comprises a process-based TEE and wherein the TEE is launched inside of a virtual machine (VM) environment.

12. The method of claim 9, comprising: providing runtime environment-agnostic images to a container registry.

13. The method of claim 9, wherein generating the bundle includes performing image service operations comprising at least one of an image pulling operation, a decryption operation, an unpacking operation, and a bundling operation.

14. The method of claim 9, comprising: parsing an application configuration and generating artifacts specific to a program execution environment operating in the TEE.

15. A computing node operating outside a virtual machine environment and including processing circuitry configured to perform operations comprising:
retrieving an application image;
generating a bundle for the application image by mounting an overlay onto the application image, the overlay including library functionality for operating in a trusted execution environment (TEE); and
providing the bundle for execution in the TEE.

16. The computing node of claim 15, wherein the TEE comprises a process-based TEE and wherein the TEE is launched outside of a virtual machine (VM) environment.

17. The computing node of claim 15, wherein the TEE comprises a process-based TEE and wherein the TEE is launched inside of a virtual machine (VM) environment.

18. The computing node of claim 15, wherein the operations include determining whether to execute the bundle within a confidential container or a non-confidential container based on configuration settings corresponding to the application image.
